(19) United States
(12) Patent Application Publication
(10) Pub. No.: US 2004/0079076 A1
(43) Pub. Date: Apr. 29, 2004

(54) Control system for a device for lifting a load

(75) Inventor: Benedito Lazaro, Ozouer Le Voulgis (FR)

Correspondence Address: LEYDIG VOIT & MAYER, LTD, 700 THIRTEENTH ST. NW, SUITE 300, WASHINGTON, DC, 20005-3960, US

(73) Assignee: HYDROPERFECT INTERNATIONAL-HPI, Chennevieres Sur Marne (FR)

(21) Appl. No.: 10/412,674

(22) Filed: Apr. 14, 2003

(30) Foreign Application Priority Data
Apr. 15, 2002 (FR) 02 04 684

(51) Int. Cl. F16D 31/02

(52) U.S. Cl. 60/477

(57) ABSTRACT

The invention concerns a control system of a device for lifting a load placed on a carrying element displaceable between a low position and an elevated position.

The system is of the type comprising a hydraulic jack (1) having a piston (2), the movement of which causes the upward and downward motion of the load-carrying element, which is capable of connection alternatively to a hydraulic fluid pump (8), and to a hydraulic fluid reservoir via a return circuit comprising at least a first valve (12) to open and close the return circuit. The system is characterized in that the return circuit comprises an opening and closing shunt valve (14) having a flow rate that is less than that of the first valve (12), which is connected parallel thereto.

The invention may be used in load-lifting devices.

The invention concerns a control system of a device for lifting a load placed on a carrying element capable of being displaced between a low position and an elevated position, of the type comprising a hydraulic jack having a piston, the movement of which causes the upward and downward motion of the load-carrying element, which can be connected either to a source of pressurized hydraulic fluid to lift the load, or to a hydraulic fluid reservoir via a return circuit for the downward motion of the load, where the return circuit comprises at least a first valve to open and close the return circuit.

It is known in particular to equip stacking trucks with such a control system. However, it has been found that any sudden change in movement of the load-carrying fork of a stacking truck, particularly to arrest the downward motion of the fork, may cause vibrations in the mechanical structure and therefore significant mechanical stresses.

To remedy this disadvantage, it is a known technique to use a delay valve as the return valve. It has been found that the major drawback to such a control system is that the delay, and thus the distance the fork travels between the time of the stop command and when it actually stops, varies as a function of the ambient temperature and the load. It has also been known to use a proportional valve in the return circuit, the major disadvantage of which is to make the system more complicated and thereby increase its cost.

The objective of the invention is to offer a control system that provides a satisfactory solution to the set of problems described above.

To realize this objective, the control system is characterized in that the return circuit comprises a shunt valve to open and close a shunt line, through which the rate of flow is lower than that of the first valve, which is mounted parallel to it.

According to one characteristic of the invention, the second valve is equipped with a flow restrictor or limiter, which may be adjustable.

According to an advantageous characteristic of the invention, the combination of the two valves in the return circuit constitutes a damping device for sudden changes in movement of the load-carrying element when it is being lowered.

According to another advantageous characteristic of the invention, the system comprises a valve in the circuit that supplies pressurized hydraulic fluid to the jack, which is capable of forming, together with the shunt valve in the return circuit, a damping device for sudden movements of the load-carrying element when it is in its lift phase.

According to yet another characteristic of the invention, in order to damp the shock of the arrest of the load-carrying element when it is being lowered, the shunt valve is closed after the return valve is closed, after the lapse of a predetermined short period of time.

According to another characteristic of the invention, in order to damp the start of a downward motion of the load-carrying element, the shunt valve is opened for a predetermined short period of time before opening the return valve.

According to yet another advantageous characteristic of the invention, in order to damp the shock of starting and arresting the lift motion of the load-carrying element, the shunt valve is opened a predetermined period of time after respectively starting and stopping the pump motor.

According to another characteristic of the invention, the valves are solenoid valves and the opening and closing of such valves is controlled by exciting the coils in such valves.

The invention will be better understood and its further objectives, characteristics, details, and advantages will be more clearly disclosed in the explanatory description that follows, made with reference to the attached schematic drawings, given by way of example only to illustrate two embodiments of the invention, in which:

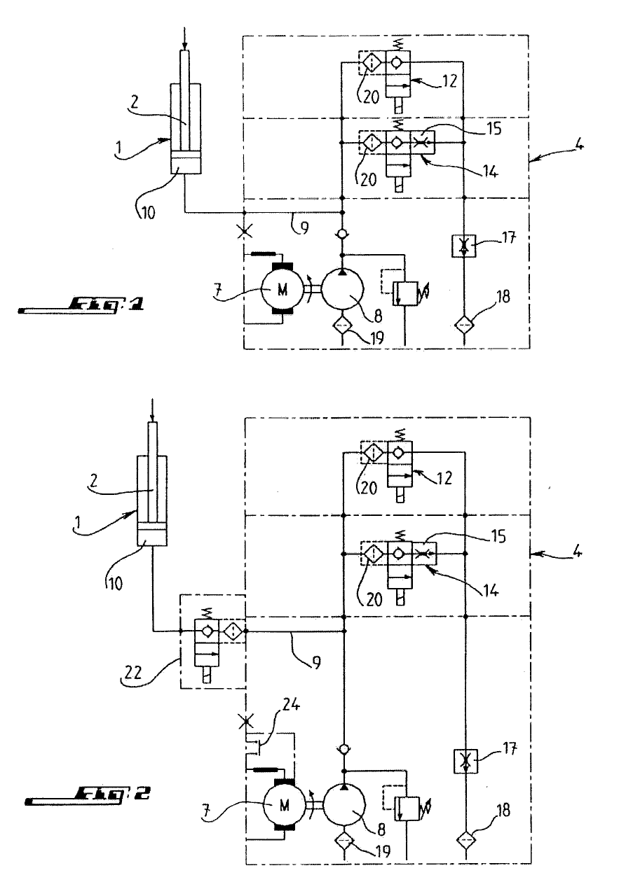

FIG. 1 is a schematic representation of a first embodiment of the control system for a load-lifting device according to the invention;

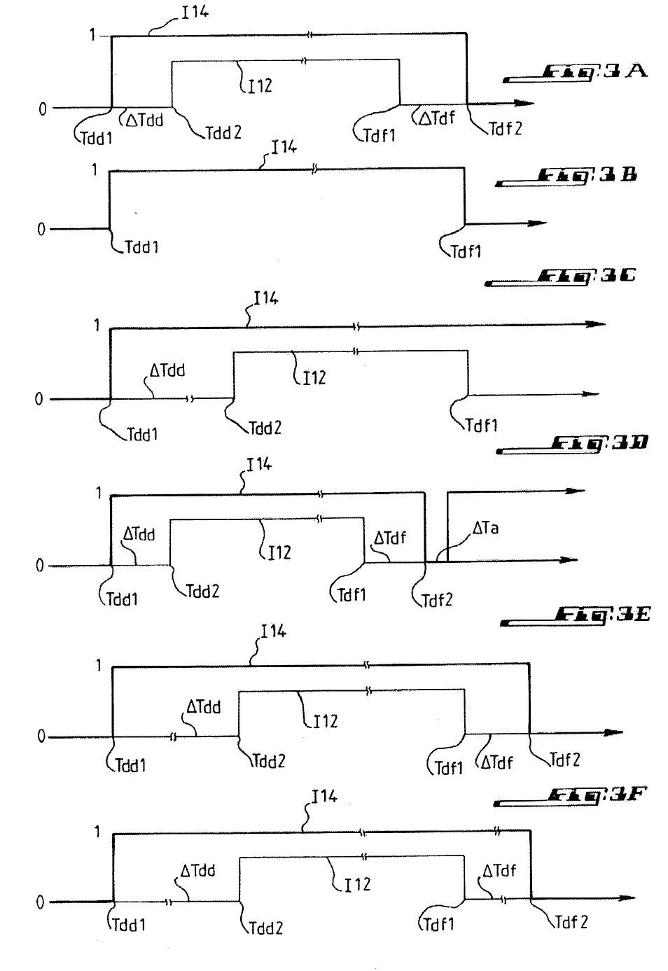

FIG. 2 is a schematic representation of a second embodiment of the control system for a load-lifting device according to the invention;

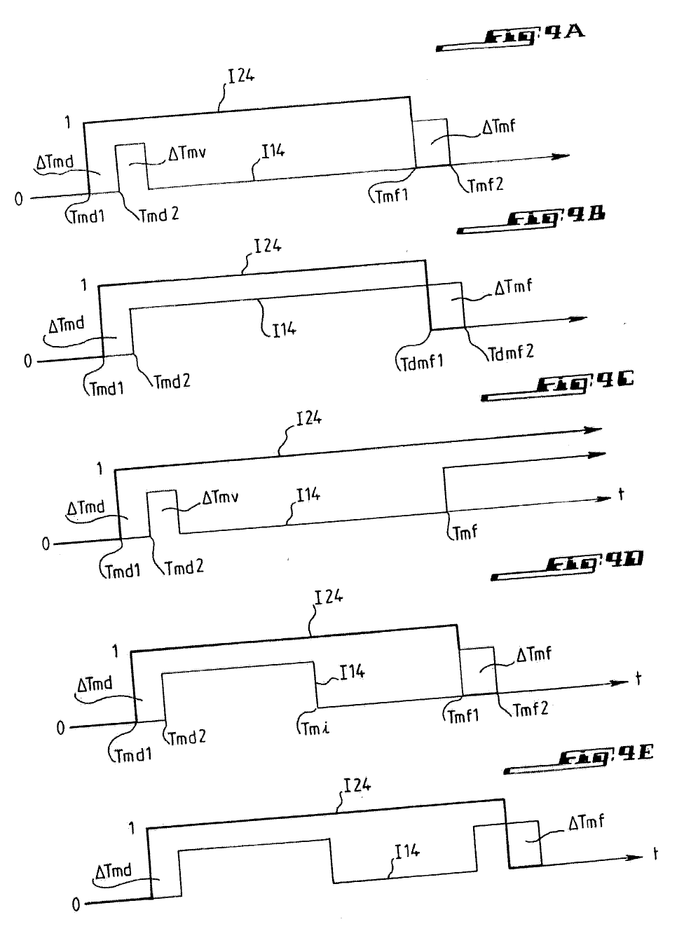

FIGS. 3A to 3F schematically illustrate various operating states of the control system according to FIG. 1, during lowering of the load-carrying element of the lifting device according to the invention; and

FIGS. 4A to 4E schematically illustrate various operating states of the control system according to the invention, when raising the load-carrying element of the lifting device.

In FIG. 1, the load-lifting device is represented only by its hydraulic jack 1, of which moving piston 2 causes displacement of the load-carrying element (not shown), where the control system is designated by reference number 4. As is known, this system comprises motor pump 6, of which motor 7 drives pump 8, which sends pressurized hydraulic fluid through a pressurized hydraulic fluid supply circuit into working chamber 10 of jack 1, after having drawn fluid into a reservoir (not shown). The delivery of pressurized fluid into chamber 10 by pump 8 causes piston 2 to make its work stroke, and thus the load-carrying restrictor of the lifting device to make its lifting motion.

Control system 4 also includes a fluid return circuit from chamber 10 to the reservoir, in which are mounted main return solenoid valve 12 and, parallel to it, shunt solenoid valve 14, the flow rate of which is less than that of valve 12. Valve 14 is equipped for this purpose with a flow reducer, restrictor, limiter, or regulator 15, which is preferably adjustable. Valves 12 and 14 are standard all-or-nothing valves. Provided upstream of the parallel assembly of two valves 12 and 14 are also series-connected flow limiter 17 and filter 18. Such a filter is also provided in the aspiration circuit of the pump. It is given reference number 19. It is further noted that valves 12 and 14 are also equipped with such a filter identified by reference number 20.

The embodiment represented in FIG. 2 comprises, in addition to the arrangement in FIG. 1, solenoid valve 22 in the pressurized fluid delivery circuit of the jack, the operation of which will be explained below. FIG. 2 also shows starter relay 24 for motor 7.

Solenoid valves 12, 14, and 22 comprise an excitation coil (not shown).

Referring now to FIGS. 3A to 3F, the following is a description of the various operating modes of the control circuit according to the invention, and therefore of the load-lifting device during the downward stroke of its load-carrying element.

FIG. 3A illustrates an operating mode of the system providing a damping effect at the start and end of the downward movement of the load-carrying restrictor, subject to the commands given by the operator of the load-lifting device, and thanks to the internal programming of the system. The way the system operates during descent is determined by the opened or closed state of the solenoid valves. The diagrams illustrate these states according to whether the coils in said valves are excited or not by application of an excitation current indicated by number 1, or the absence of excitation current indicated by 0.

Before the load-carrying restrictor starts its descent, the two solenoid valves are closed, i.e., the excitation current through the coils is zero. Precisely at time Tdd1, the operator commands the start of the downward motion, which is triggered initially and immediately at that instant by current I14 flowing through the coil of shunt valve 14, which causes the latter to open. As a result, hydraulic fluid is able to flow through said valve at a low rate. After predetermined delay ΔTdd, precisely at time Tdd2, the excitation of the coil in solenoid valve 12 is triggered when excitation current I12 is delivered. Given that the fluid returning from working chamber 10 to the reservoir occurs initially at a relatively low rate of flow through shunt valve 14 and only later, after the lapse of relatively short predetermined time period Tdd, at a higher rate through main return valve 12, the load-carrying restrictor starts to descend fairly slowly and only later, after delay ΔTdd programmed in the system, does it descend at a higher speed determined by valve 12. In other words, the speed increases slowly, without jolts. Precisely at time Tdf1, the operator commands the end of the downward motion. The order to end or stop the descent at time Tdf1 immediately stops application of excitation current I12 to main valve 12, thereby closing it, while valve 14 remains open during delay ΔTdf until time Tdf2. Consequently, at the end of the descent, the fluid continues to return during time ΔTdf, at a lower rate through shunt valve 14, whereas, if the duration is too long, the speed increases or decreases slowly.

It is easy to see that by keeping time periods ΔTdd and ΔTdf constant, for example, by means of an electronic device equipped with a stabilizing crystal oscillator, the system according to the invention makes it possible to perfectly control the damping phases of the movement of the load-carrying restrictor at both the start and the end of the descent, where the starting and ending speeds are gradually slowed as a function of the choice of these time periods in order to obtain the damping effect. In order to avoid any sudden change of speed, which the invention aims to eliminate, these time periods should not be too short.

FIG. 3B shows the conditions for lowering a load-carrying restrictor at a slow speed at the start and the end of the descent, with hydraulic fluid returning to the reservoir exclusively through shunt valve 14, which is now open thanks to the excitation of the coil of said valve between time Tdd1 at the start of the descent and time Tdf1 in the period near the end. Given that descent occurs slowly, there is no need to damp the shock of starting and stopping the load-carrying element.

FIG. 3C illustrates the manner in which it is possible to produce a slow speed for the start of descent by the appropriate command at time Tdd1 to open shunt valve 14 and then, by a command given by the operator at time Tdd2, to open main return valve 12. At Tdd2, descent occurs quickly thanks to the higher flow rate through valve 12. At time Tdf1, the operator commands valve 12 to be closed so that the returning fluid is only able to flow through shunt valve 14. Consequently, at Tdf1, descent continues at a slow speed produced by the low flow rate permitted by valve 14.

FIG. 3D illustrates an operating mode in which the start and end of descent of the load-carrying restrictor are damped, as in the case in FIG. 3A, but where it is provided that, after a lapse of stop time Δta, descent continues slowly by again opening only shunt valve 14.

FIGS. 3E and 3F illustrate two operating modes which have in common that at time Tdd1 the operator initially commands shunt valve 14 to be opened and accordingly starts to lower the load-carrying element at a slow speed, and then, after a time period greater than damped delay ΔTdd, the opening of valve 12 triggers a faster descent. According to FIG. 3E, the operator gives the command at time Tdf1 for the end of descent with damping, which causes valve 12 to close at that instant and causes shunt valve 14 to close at time Tdf2, after the lapse of relatively brief damping time ΔTdf. In the context of the operating mode according to FIG. 3F, the end of descent occurs without damping. At time Tdf1, the operator commands main valve 12 to close and then later gives the command to close shunt valve 14 at time Tdf2.

FIGS. 4A to 4E illustrate a certain number of operating modes when raising the load-carrying element.

FIG. 4A illustrates the control of two solenoid valves 12 and 14 with damping at the start and the end of the lift. The lift command starts here, as in all cases, by excitation of starter relay 24 for motor 7, illustrated by curve 124. The shock from the start of the lift is damped when, after exciting relay 24, after short predetermined delay ΔTmd, shunt valve 14 is opened at time Tmd2. This valve is then closed after appropriate delay ΔTmv. For a damped start of the lift, delay time ΔTmd is programmed. In other words, the operator simply must control the start of the lift at time Tmd1 in order for relay 24 to be excited, and the motor begins to operate pump 8, and then, after delay ΔTmd, valve 14 is automatically opened for period ΔTmv. Damping is produced since some of the pressurized fluid sent by the pump to jack 1 passes through shunt valve 14. Valve 22 in the pressurized fluid supply circuit to the jack serves to permit fluid flow from the pump to the jack, but not in the opposite direction during the lift phase with damping. Valve 22 thereby constitutes, together with shunt valve 14 in the return circuit, a damping device against sudden changes in motion of the load-carrying element during its lift phase, valve 22 therefore being open to allow fluid to flow to the jack, but not in the opposite direction.

In FIG. 4A, the end of the lift is also damped. In order for the final phase of the lift to be carried out in this way, at time Tmf1, the operator activates a control device whereby, at that point in time, starter relay 24 ceases to be excited. This causes the supply of pressurized hydraulic fluid to jack 1 to stop, and also causes shunt valve 14 to open at that time for predetermined time period ΔTmf. Within the context of the operating mode according to FIG. 4A, the start and the end of the lift are damped and the lift occurs at high speed since, except for the starting and ending phases, shunt valve 14 is closed.

FIG. 4B illustrates the lift with the start and end of the lift damped; moreover, the lift proceeds at a slow speed since shunt valve 14 remains open after the start and until the end of the lift.

FIG. 3C illustrates the case of a high-speed lift with damping at the start, as in FIG. 4A, the difference being, however, that the high-speed lift ends at time Tfm by opening shunt valve 14. The lift then continues at a slower speed, with, of course, starter relay 24 remaining excited.

FIG. 4D illustrates a slow speed lift until intermediate time Tmᵢ, when the shunt valve is closed so that the rest of the lift proceeds at high speed but ends according to FIG. 4B, with damping, by again opening shunt valve 14 for programmed brief damping delay ΔTmf.

The operating mode in FIG. 4E is distinguished from 4D by the fact that the lift starts with damping, proceeds at slow speed and then at high speed, but provides for an end of the lift at a slow speed during the period when shunt valve 14 is open.

To return to valve 22, it is evident that this valve is used to retain the load when the system is used in the lift mode. In effect, during the start phase of electric motor 7, some of the flow is sent through valve 14 for a predetermined period of time. In the absence of valve 22, the load would drop during the entire time valve 14 is open; thus, it may be referred to as a load retention valve. During descent, valve 22 is open simultaneously with valve 14.

It should be noted that various modifications may be made to the invention as described above and represented in the figures. It is possible to provide yet another shunt valve in parallel with shunt valve 14, with a different flow rate perhaps, in order to obtain a lift or descent process capable of meeting certain demands involving the operation of the lifting device. It should be noted that the solenoid valves used within the context of the invention are standard valves operating on an all-or-nothing basis. It is possible to use a valve equipped with an adjustable flow control device as a low-flow shunt valve. Within the context of the invention, it is essential that the command to start or end a lift or descent with damping be achieved by a single command from the operator, which then activates a single element provided for that purpose so that, initially, one of the two valves is activated, which automatically results in activation of the other valve after a predetermined period of time. It should be noted that the delay between the two activations should be chosen so as not to be too brief, in order to prevent any sudden changes in operation and the resulting mechanical stresses.

1. Control system of a device for lifting a load, placed on a carrying element capable of being displaced between a low position and an elevated position, of the type comprising a hydraulic jack (1) having a piston (2), the movement of which causes the upward and downward motion of the load-carrying element, which can be connected alternatively to a source of pressurized hydraulic fluid to lift a load, and to a hydraulic fluid reservoir via a return circuit for the downward motion of the load, where the return circuit comprises at least a first valve (12) to open and close the return circuit as well as an opening and closing shunt valve (14) with a flow rate which is less than that of the first valve (12), and which is mounted parallel thereto, characterized in that both the first valve (12) and the shunt valve (14) operate on an all-or-nothing basis, and in that it comprises damping means against any sudden changes in motion of the load-carrying element by controlling the opening and closing of the valves in relation to the sudden motion of the load-carrying element.

2. System according to claim 1, characterized in that the shunt valve (14) is equipped with a flow reducer, flow restrictor, flow limiter, or flow regulator (15), which may be adjustable.

3. System according to claim 1 or 2, characterized in that the combination of the two valves (12,14) in the return circuit constitutes a damping device for sudden changes in movement of the load-carrying element during its descent.

4. System according to one of claims 1 through 3, characterized in that it also comprises a valve (22) in the circuit to supply pressurized hydraulic fluid to the jack (1), which is capable of constituting, together with the shunt valve (14) in the return circuit, a damping device for sudden changes in motion of the load-carrying element when it is in its lift stroke, where the valve (22) is open to permit fluid to flow to the jack, but not in the opposite direction.

5. System according to one of claims 1 through 4, characterized in that in order to damp the shock of stopping the load-carrying element when it is being lowered, the shunt valve (14) is closed after the main return valve (12), after the lapse of a predetermined short period of damping time (ΔTdf).

6. System according to one of claims 1 through 5, characterized in that in order to damp the start of a downward motion of the load-carrying element, the shunt valve (14) is opened for a predetermined period of time (ΔTdd) before the main return valve (12) is opened.

7. System according to one of claims 1 through 6, characterized in that in order to damp the shock of starting and stopping the lift motion of the load-carrying element, the shunt valve (14) is opened for a predetermined period of time (ΔTmd, ΔTmf) after respectively starting and stopping the motor (7) to the pump (8).

8. System according to one of claims 1 through 7, characterized in that in order to damp the shock of starting the lift motion of the load-carrying restrictor, the shunt valve (14) is opened for a predetermined period of time (ΔTmd) after starting the motor (7) to the pump (8), and is then closed after a predetermined delay (ΔTmv).

9. System according to one of claims 1 through 8, characterized in that in order to damp the shock of stopping the upward motion of the load-carrying element, the shunt valve (14) is open for a predetermined delay (ΔTmf) after turning off the motor (7) to the pump (8).

10. System according to one of claims 1 through 7, characterized in that the valves (12,14) are solenoid valves and in that the opening and closing of the valves is controlled by exciting the coils of such valves.
